(19) United States
(12) Patent Application Publication
(10) Pub. No.: US 2014/0354609 A1
(43) Pub. Date: Dec. 4, 2014

(54) LIQUID CRYSTAL DISPLAY DEVICE AND METHOD OF DRIVING LIQUID CRYSTAL DISPLAY DEVICE

(71) Applicant: SHARP KABUSHIKI KAISHA, Osaka (JP)

(72) Inventor: Daiichi SAWABE, Osaka-shi (JP)

(73) Assignee: SHARP KABUSHIKI KAISHA, Osaka (JP)

(21) Appl. No.: 14/188,967

(22) Filed: Feb. 25, 2014

(30) Foreign Application Priority Data
May 30, 2013 (JP) 2013-114570

(51) Int. Cl. G09G 3/36

(52) U.S. Cl. CPC G09G 3/3648
USPC 345/204; 345/87

(57) ABSTRACT

A minimum electric potential of electric potentials (source waveforms (VS)), which are applied, in accordance with image data, to source terminals of respective switching elements each being a thin film transistor provided in a corresponding picture element, is set to be lower than a ground electric potential. This makes it possible to provide a liquid crystal display device in which each picture element is difficult to accumulate an electric charge when a power supply is turned off.

This Nonprovisional application claims priority under 35 U.S.C. §119 on Patent Application No. 2013-114570 filed in Japan on May 30, 2013, the entire contents of which are hereby incorporated by reference.

### TECHNICAL FIELD

The present invention relates to a technique for discharging an electric charge of each picture element of a liquid crystal display device when a power supply to the liquid crystal display device is turned off.

### BACKGROUND ART

It has been conventionally known that, in a case where electric fields of identical polarities are continuously applied to picture elements (or pixels) of a liquid crystal display device, polarization of liquid crystal molecules occurs, thereby causing a problem such as image sticking and a change in characteristic of a picture element.

It has also been known that a phenomenon of image sticking occurs in a case where a power supply to a liquid crystal display device is turned off while displaying an image. This is because a voltage, applied to each of picture elements immediately before the power supply is turned off, remains to be applied to the each of the picture elements, i.e., the same image is continuously drawn.

In view of the circumstances, a conventional liquid crystal display device is configured such that, when a power supply to the liquid crystal display device is turned off, a given off-sequence is carried out for discharging an electric charge which has been applied to each of picture elements of a liquid crystal display panel.

For example, Patent Literature 1 discloses a technique in which an electrolytic capacitor is further provided in a power supply circuit so that, when a power supply to a liquid crystal display device is turned off, processing is carried out in which a given fixed pattern is drawn on an entire screen of a liquid crystal display panel by use of an electric charge which has been accumulated in the electrolytic capacitor. This causes a reduction in electric charge which has been accumulated in each of picture elements.

### CITATION LIST

### Patent Literatures

Patent Literature 1
Japanese Patent Application Publication, Tokukai, No. 2000-131671 A (Publication Date: May 12, 2000)

### SUMMARY OF INVENTION

### Technical Problem

In recent years, a liquid crystal display device has been developed in which it is intended to reduce (a) a vertical shadow and (b) electric power consumption which is caused by an intermittent drive, by use of a TFT (Thin Film Transistor) that (i) is made of oxide semiconductor (e.g., indium-gallium-zinc oxide semiconductor) or the like and (ii) has a small off-leak electric current.

However, this type of liquid crystal display device has a characteristic in which it is difficult to discharge an electric charge which has been accumulated in a picture element, when a power supply to the liquid crystal display device is turned off. This is because such a TFT, made of oxide semiconductor, has an off-leak electric current which is much smaller than that of TFT, made of a material such as amorphous silicon or low-temperature polysilicon, which TFT is employed in a conventional liquid crystal display device.

FIG. 17 is a graph in which off-leak electric current characteristics are compared among a TFT made of indium-gallium-zinc oxide semiconductor, a TFT made of low-temperature polysilicon (LTPS), and a TFT made of amorphous silicon (a-Si). Note that, in the graph of FIG. 17, (i) a horizontal axis indicates an electric potential difference between a gate and a source (Vg−Vs) and (ii) a vertical axis indicates an electric current flowing through the source and a drain.

As is clear from FIG. 17, the TFT made of indium-gallium-zinc oxide semiconductor has a characteristic in which an off-leak electric current is (i) 1/1000 or less of an off-leak electric current of the TFT made of amorphous silicon and (ii) 1/10000 or less of an off-leak electric current of the TFT made of low-temperature polysilicon.

The TFT, made of oxide semiconductor, has the characteristic in which an off-leak electric current is small. Such a characteristic improves a characteristic which is obtained during driving (e.g., reduction in electric power consumption) but causes a problem that it is difficult to discharge an electric charge which has been charged in a picture element electrode when a power supply to a liquid crystal display device is turned off. In a case where the electric charge remains in the picture element electrode, an electric potential difference between the picture element electrode and a counter electrode causes an electric field to be applied, in a certain direction, to a liquid crystal layer. This causes polarization of liquid crystal molecules made of polar molecules, thereby causing a problem such as deviation in characteristic and image sticking.

As such, in a case where a TFT which (i) is made of oxide semiconductor or the like and (ii) has a small off-leak electric current is employed, a problem such as image sticking may occur. This is because even in a case where an electric charge, which has been accumulated in a picture element is reduced, by the processing disclosed in Patent Literature 1, when a power supply is turned off, the electric charge cannot be completely discharged by the processing and may remain in the picture element. According to the technique disclosed in Patent Literature 1, it is necessary to separately provide (i) a circuit for an off-sequence and (ii) charging means, such as an electric field effect capacitor, for charging electric power required for the off-sequence. This also causes a problem of increasing a production cost.

The present invention has been made in view of the problems, and an object of the present invention is to provide a liquid crystal display device in which a picture element is difficult to accumulate an electric charge when a power supply is turned off.

### Solution to Problem

A liquid crystal display device of an embodiment of the present invention includes: a plurality of picture elements having respective switching elements each being constituted by a thin film transistor, the liquid crystal display device driving, in accordance with image data, picture elements corresponding to respective thin film transistors by applying electric potentials corresponding to the image data to source terminals of the respective thin film transistors during a period in which an electric potential for turning on the thin film transistors is applied to gate terminals of the respective thin film transistors, a minimum electric potential of the electric potentials which are applied to the respective source terminals in accordance with the image data being set to be lower than a ground electric potential.

### Advantageous Effects of Invention

With the configuration, it is possible for an electric potential of each of the source terminals to get close to the ground electric potential when a power supply to the liquid crystal display device is turned off, as compared with a conventional liquid crystal display device in which a minimum electric potential of electric potentials which are applied to source terminals in accordance with image data is the ground electric potential. This allows an increase in off-leak electric current which each of the switching elements has when the power supply is turned off. As such, it is possible to facilitate discharging of an electric charge which has been accumulated in each of the picture elements.

### BRIEF DESCRIPTION OF DRAWINGS

FIG. 1 is an explanatory diagram illustrating a schematic configuration of a liquid crystal display device of an embodiment of the present invention.

FIG. 2 is an explanatory diagram illustrating a configuration of a liquid crystal panel provided in the liquid crystal display device illustrated in FIG. 1.

FIG. 3 is an explanatory diagram illustrating a configuration of a TFT substrate provided in the liquid crystal panel illustrated in FIG. 2.

FIG. 4 is an explanatory diagram illustrating a configuration of a picture element provided in the liquid crystal panel illustrated in FIG. 2.

FIG. 5 is an equivalent circuit diagram of the picture element illustrated in FIG. 4.

FIG. 6 is an explanatory diagram illustrating an example circuit configuration of a low-level side power supply circuit of a source power supply circuit provided in the liquid crystal display device illustrated in FIG. 1.

FIG. 7 is an explanatory diagram illustrating a configuration of a gate driver provided in the liquid crystal display device illustrated in FIG. 1.

FIG. 8 is an explanatory diagram illustrating waveforms of output signals of the gate driver illustrated in FIG. 7.

FIG. 9 is an explanatory diagram illustrating an example circuit configuration employed as an output stage of the gate driver illustrated in FIG. 7.

FIG. 10 is an explanatory diagram illustrating an example circuit configuration of a gradation DAC provided in the liquid crystal display device illustrated in FIG. 1.

FIG. 11 is an explanatory diagram illustrating a configuration of a source driver provided in the liquid crystal display device illustrated in FIG. 1.

FIG. 12 is an explanatory diagram illustrating timings when voltages are applied to source bus lines and gate bus lines of the liquid crystal display device illustrated in FIG. 1.

FIG. 13 is an explanatory diagram illustrating a circuit configuration of a gradation electric potential generation circuit provided in the source driver illustrated in FIG. 11.

FIG. 14 is an explanatory diagram illustrating an example circuit configuration employed as an output stage of the source driver illustrated in FIG. 11.

(a) of FIG. 15 is an explanatory diagram illustrating example waveforms of respective voltages to be applied to each of picture elements of the liquid crystal display device illustrated in FIG. 1. (b) of FIG. 15 is an explanatory diagram illustrating example waveforms of respective voltages to be applied to each of picture elements of a liquid crystal display device of a conventional example.

FIG. 16 is an explanatory diagram illustrating how to adjust an applied voltage corresponding to a gradation value of the liquid crystal display device illustrated in FIG. 1.

FIG. 17 is an explanatory diagram illustrating off-leak electric current characteristics corresponding to respective types of TFTs.

### DESCRIPTION OF EMBODIMENTS

The following description will discuss an embodiment of the present invention.

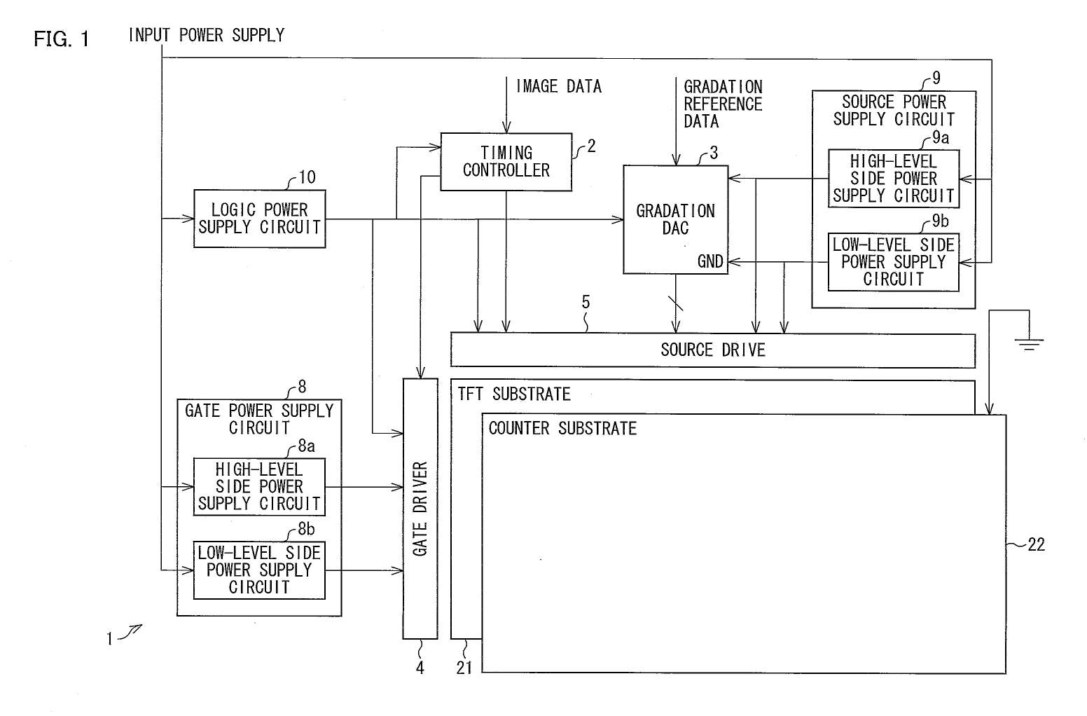

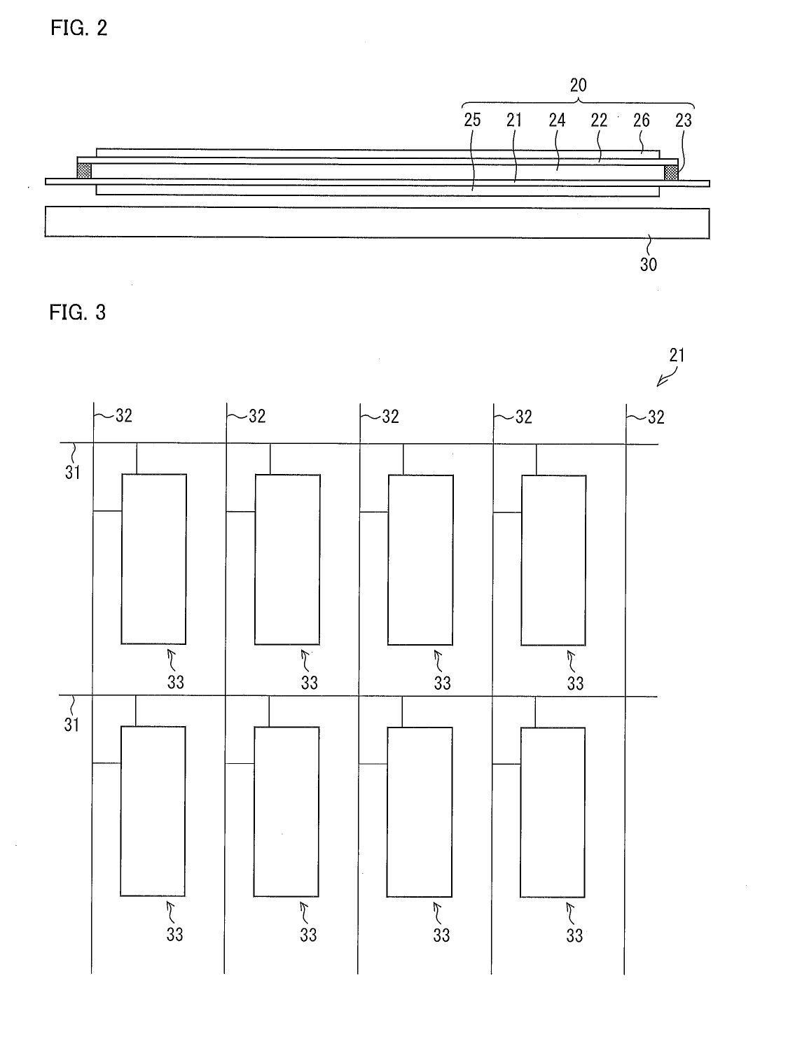

FIG. 1 is an explanatory diagram illustrating a schematic configuration of a liquid crystal display device 1 of the present embodiment. FIG. 2 is an explanatory diagram illustrating a configuration of a liquid crystal panel 20 provided in the liquid crystal display device 1.

As illustrated in FIG. 2, the liquid crystal panel 20 includes (i) a TFT substrate 21 and a counter substrate 22 which are provided so as to face each other via a spacer 23, (ii) a liquid crystal layer 24 which is made of liquid crystal material filled between the TFT substrate 21 and the counter substrate 22, (iii) a first polarizing plate 25 provided on a back surface side of the TFT substrate 21 (i.e., a side of a surface opposite to a surface facing the counter substrate 22), (iv) a second polarizing plate 26 provided in a front surface side of the counter substrate 22 (i.e., a side of a surface opposite to a surface facing the TFT substrate 21). A backlight 30 is provided behind the liquid crystal panel 20.

The first polarizing plate 25 transmits, among light emitted from the backlight 30, only light having polarized light corresponding to a polarization axis direction of the first polarizing plate 25. A voltage, corresponding to image data, is applied to the liquid crystal layer 24 of each picture element. This causes birefringence of a liquid crystal corresponding to the each picture element to change in accordance with the image data. Accordingly, a polarization direction of light, passing through the each picture element, changes in accordance with the image data. Moreover, the second polarizing plate 26 transmits, among light which has passed through the liquid crystal layer 24, only light having polarized light corresponding to a polarization axis direction of the second polarizing plate 26. This causes an amount of light transmitted through the liquid crystal panel 20 to be controlled for each picture element and in accordance with the image data, thereby causing an image to be displayed.

One of color filters R (red), G (green), and B (blue) is provided in a region corresponding to each picture element (subpixel) of the counter substrate 22. One pixel is constituted by three picture elements (i.e., R, G, and B) in combination. This causes an amount of light transmitted through each of R, G, and B of a pixel to be controlled for each pixel and in accordance with the image data, thereby causing an image to be displayed.

FIG. 3 is an explanatory diagram illustrating a schematic configuration of a TFT substrate 21. There are provided, on the TFT substrate 21, (i) a large number of gate bus lines 31, (ii) a large number of source bus lines 32, which are provided so as to intersect with the gate bus lines 31, and (iii) picture elements 33 provided for respective intersections of the gate bus lines 31 and the source bus lines 32 (see FIG. 3).

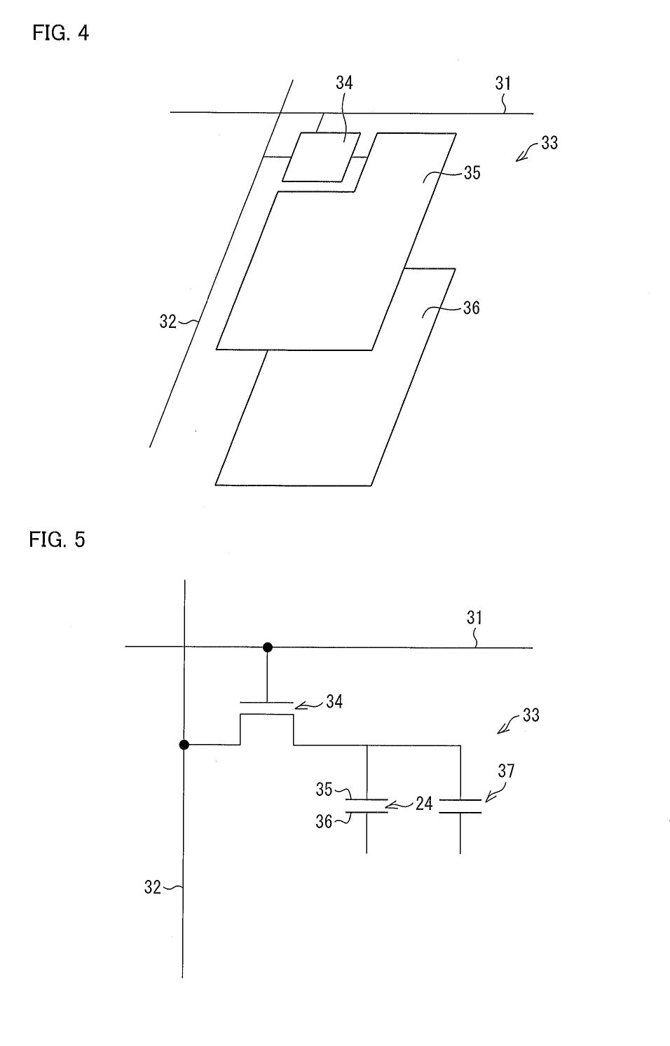

FIG. 4 is an explanatory diagram illustrating a configuration of each of the picture elements 33 provided in the liquid crystal panel 20.

Each of the picture elements 33 includes (i) a TFT (Thin Film Transistor) 34 serving as a switching element, (ii) a picture element electrode 35, and (iii) a counter electrode 36 (see FIG. 4). The TFT 34 has a gate terminal, a source terminal, and a drain terminal which are connected to the gate bus line 31, the source bus line 32, and the picture element electrode 35, respectively.

Note that the present embodiment employs a TFT, which serves as a TFT 34, including a channel layer made of indium-gallium-zinc oxide semiconductor (oxide semiconductor). Note, however, that a configuration of the TFT 34 is not limited to this. Alternatively, it is possible to employ a TFT including (i) a channel layer which is made of, for example, oxide semiconductor other than indium-gallium-zinc oxide semiconductor or (ii) a channel layer which is made of a material other than oxide semiconductor (e.g., amorphous silicon, low-temperature polysilicon, etc.).

The gate bus lines 31 are each connected to a gate driver 4, and the source bus lines 32 are each connected to a source driver 5. A counter reference electric potential (i.e., a ground (GND) electric potential in the present embodiment) is applied to the counter electrode 36, via a counter wire (not illustrated) provided on the counter substrate 22.

During displaying of an image, the gate driver 4 periodically selects a gate bus line 31, via which writing is carried out. And, in synchronization with the gate driver 4, the source driver 5 applies, to a source bus line 32 corresponding to a picture element 33 connected to a selected gate bus line 31, a voltage in accordance with a gradation value of image data. This causes an orientation direction of each of the liquid crystal molecules to be controlled in accordance with a voltage, corresponding to the image data, to be applied to the liquid crystal layer 24 of the picture element 33, thereby causing an image to be displayed.

FIG. 5 is an equivalent circuit diagram of a picture element 33. In a case where an electric potential of a gate terminal of the TFT 34 is higher than that of a source terminal of the TFT 34 by a given value or more, the TFT 34 is turned on. An electric current flows through the source terminal and the drain terminal, accordingly. This causes an electric potential of a source bus line 32 to be applied to a liquid crystal capacitor (a liquid crystal layer 24). According to the equivalent circuit diagram illustrated in FIG. 5, the picture element electrode 35, the counter electrode 36, and the liquid crystal layer 24 are illustrated as a capacitor. Note that the example illustrated in FIG. 5 includes a liquid crystal storage capacitor (CS capacitor) 37 which (i) is arranged in parallel to a liquid crystal capacitor (defined by the picture element electrode 35, the liquid crystal layer 24, and the counter electrode 36) and (ii) is provided for maintaining an electric potential of the picture element 33. Note, however, that the liquid crystal storage capacitor 37 is not an essential component and can therefore be omitted. Note that, according to the present embodiment, an electric potential of an electrode, provided on a side opposite to a side on which an electrode provided on a TFT 34 side of the liquid crystal storage capacitor 37 is provided, is set to the ground (GND) electric potential, as with an electric potential of the counter electrode 36. Note, however, that such an electric potential of the electrode is not limited to this. Alternatively, it is possible to set the electric potential of the electrode to an electric potential different from that of the counter electrode 36.

Note that the present embodiment has been described on the premise that the picture elements R, G, and B are included. Note, however, that the present embodiment is not limited to this. Alternatively, a picture element in other colors can be included.

In addition to the liquid crystal panel 20 and the backlight 30, the liquid crystal display device 1 further includes a timing controller 2, a gradation DAC (gradation digital/analog converter) 3, the gate driver 4, the source driver 5, a gate power supply circuit 8, a source power supply circuit 9, and a logic power supply circuit 10 (see FIG. 1).

The logic power supply circuit 10 supplies electric power to logic circuits (not illustrated) provided in the timing controller 2, the gradation DAC 3, the gate driver 4, and the source driver 5.

The gate power supply circuit 8 supplies driving electric power to the gate driver 4. The gate power supply circuit 8 includes (a) a high-level side power supply circuit 8a which supplies a high-level side voltage to the gate driver 4 and (b) a low-level side power supply circuit 8b which supplies a low-level side voltage to the gate driver 4. Note that a configuration of each of the high-level side power supply circuit 8a and the low-level side power supply circuit 8b is not particularly limited. A conventionally known power supply circuit can therefore be employed as each of the high-level side power supply circuit 8a and the low-level side power supply circuit 8b.

The source power supply circuit 9 supplies driving electric power to the source driver 5. The source power supply circuit 9 includes (a) a high-level side power supply circuit 9a which supplies a high-level side power supply electric power to the source driver 5 and (b) a low-level side power supply circuit 9b which supplies a low-level side power supply electric power to the source driver 5. Note that the high-level side power supply circuit 9a also supplies analog electric power to the gradation DAC 3 and the low-level side power supply circuit 9b also supplies electric power to a ground (GND) terminal of the gradation DAC 3.

Note also that, according to the present embodiment, a minimum electric potential, corresponding to a low-level side voltage which is supplied from the low-level side power supply circuit 9b to the source driver 5, is set to be lower than the ground (GND) electric potential (described later in detail).

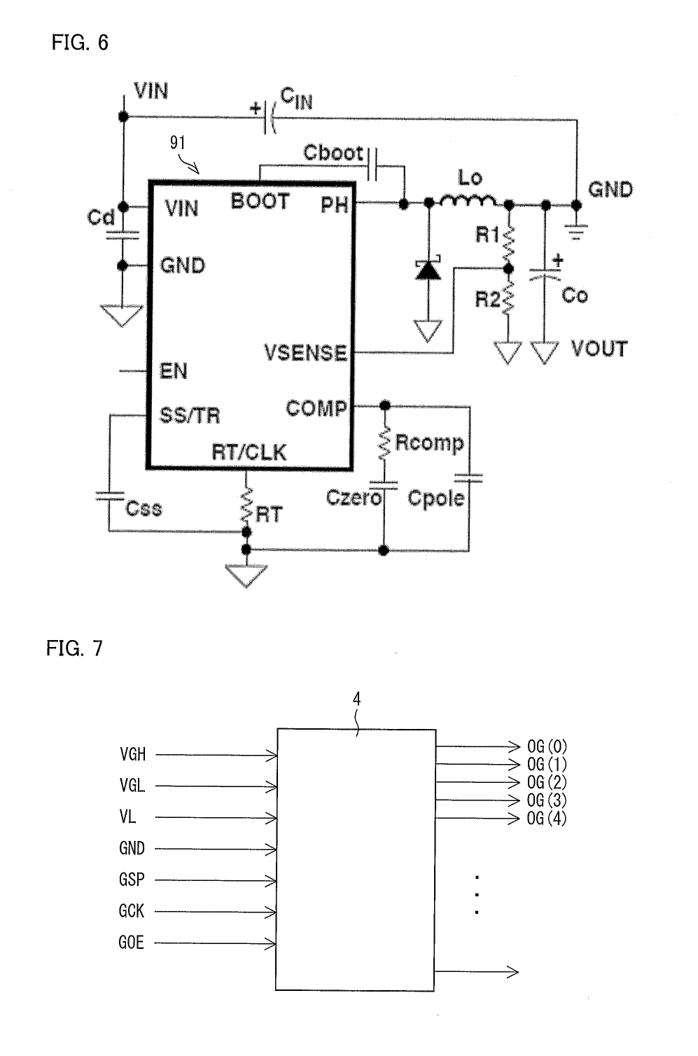

FIG. 6 is an explanatory diagram illustrating an example circuit configuration of the low-level side power supply circuit 9b. The low-level side power supply circuit 9b includes a step-down converter 91 (see FIG. 6). The low-level side power supply circuit 9b (i) converts an input voltage (input electric potential) VIN into an output voltage (output electric potential) VOUT which is lower than the ground (GND) electric potential and then (ii) outputs the output voltage thus converted. According to the present embodiment, an input voltage of 12V is supplied from an electric power supply source (not illustrated) to the source power supply circuit 9. The low-level side power supply circuit 9b then generates, from the input voltage of 12V, an output voltage of −6V and outputs the output voltage thus generated. A circuit configuration of the step-down converter 91 is not particularly limited. For example, TPS54050 (a product name, manufactured by Texas Instruments Co., Ltd) can be employed as a step-down converter 91. The employment of the low-level side power supply circuit 9b having such a circuit configuration makes it possible to constitute, at low cost, a power supply having a high capacity. Note that a circuit configuration of the low-level side power supply circuit 9b is not limited to that illustrated in FIG. 6, provided that it is configured to output a voltage (electric potential) lower than the ground (GND) electric potential. A circuit configuration of the high-level side power supply circuit 9a is also not particularly limited. A conventionally known power supply circuit can therefore be employed as the high-level side power supply circuit 9a.

The timing controller 2 (i) generates, in accordance with image data externally supplied (e.g., supplied from a control section of the liquid crystal display device 1), a control signal for controlling an operation of each of the gate driver 4 and the source driver 5 and then (ii) supplies the control signal thus generated to each of the gate driver 4 and the source driver 5.

The gate driver 4 periodically selects a gate bus line 31, via which writing is carried out, by controlling, in accordance with the control signal supplied from the signal timing controller 2, a voltage to be applied to each of gate bus lines 31 provided on the TFT substrate 21 of the liquid crystal panel 20.

FIG. 7 is an explanatory diagram illustrating a configuration of the gate driver 4. A high-level side voltage VGH to be applied to a gate bus line 31, a low-level side voltage VGL to be applied to a gate bus line 31, a logic power supply voltage VL, and a ground electric potential (reference electric potential) GND for logic circuits are each supplied to the gate driver 4 (see FIG. 7). Note that the high-level side voltage VGH, the low-level side voltage VGL, and the logic power supply voltage VL are supplied to the gate driver 4 from the high-level side power supply circuit 8a, the low-level side power supply circuit 8b, and the logic power supply circuit 10, respectively.

A gate start pulse GSP, a gate clock signal GCK, and a gate enable signal GOE are each supplied from the timing controller 2 to the gate driver 4. G1, G2, . . . , G2160 are connected to a first gate bus line 31, a second gate bus line 31, . . . , a 2160th gate bus line 31 of the liquid crystal panel 20, respectively.

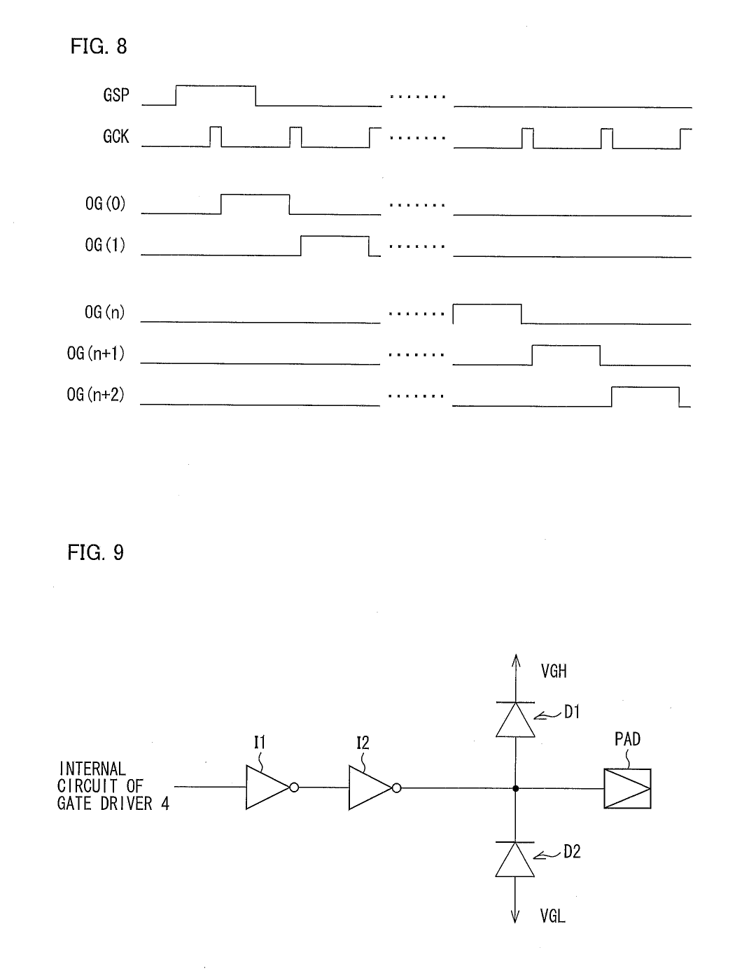

FIG. 8 illustrates drive waveforms of the gate driver 4 (waveforms of output signals which are supplied from the gate driver 4 to the respective gate bus lines 31). After the gate start pulse GSP is supplied to the gate driver 4, in synchronization with the gate clock signal GCK, a high-level voltage is applied to the gate bus lines 31 one by one in sequence (see FIG. 8). Note, however, that the drive waveforms of the gate driver 4 are not limited to such, and a conventionally known driving method can therefore be employed.

FIG. 9 is an explanatory diagram illustrating an example circuit configuration employed as an output stage of the gate driver 4. According to the output stage of the gate driver 4, an inverter I1, an inverter I2, and an output terminal PAD are connected in series (see FIG. 9). A high-level side power supply (i.e., a supply source of the high-level side voltage VGH) is connected between the inverter I2 and the output terminal PAD via a diode D1, whereas a low-level side power supply (i.e., a supply source of the low-level side voltage VGL) is connected between the inverter I2 and the output terminal PAD via a diode D2. Each output terminal PAD is connected to a corresponding one of the gate bus lines 31. This causes (i) a high-level side of a data signal which is supplied from an internal circuit of the gate driver 4 and (ii) a low-level side of the data signal to be level-shifted to the high-level side voltage VGH and the low-level side voltage VGL, respectively, so as to be sequentially applied to the gate bus lines 31.

Specifically, the high-level voltage is applied, one by one in sequence, to the gate bus lines 31 (see FIG. 8). This causes the TFTs 34 of the picture elements 33, connected to the respective gate bus lines 31, to be sequentially turned on. Voltages corresponding to image data are applied (charged), via respective source bus lines 32, only to picture elements 33 in which the respective TFTs 34 are turned on. Note that a method in which display is carried out for each gate bus line is called line-sequential driving. According to the line-sequential driving, voltages corresponding to the image data are applied to the picture elements 33 for each bus line. By thus applying the voltages to all the gate bus lines one by one, display for one (1) screen is carried out.

The gradation DAC 3 (i) generates, in accordance with gradation reference data (i.e., output voltage value data) externally supplied (e.g., supplied from a control section of the liquid crystal display device 1), a gradation reference voltage which is used when the source driver 5 generates a voltage corresponding to a gradation value and then (ii) supplies the gradation reference voltage thus generated to the source driver 5. Note that the gradation reference data is set, for example, when the liquid crystal display device 1 is produced so as to adjust variation in optimum gradation voltage which variation is caused by a floating capacitance of a picture element, which floating capacitance varies from liquid crystal panel to liquid crystal panel.

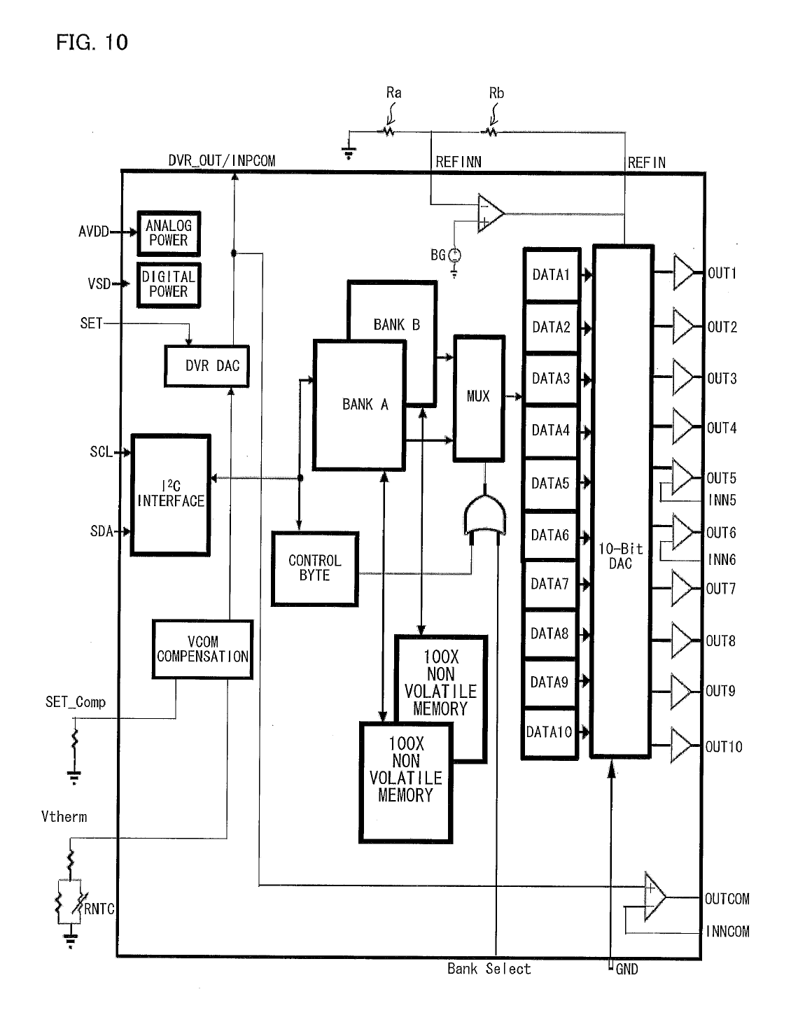

FIG. 10 is an explanatory diagram illustrating an example circuit configuration of the gradation DAC 3. The gradation DAC 3 has an AVDD terminal, a VSD terminal, an SET terminal, an SCL terminal, an SDA terminal, an OUT/INPCOM terminal, an OUTCOM terminal, an INNCOM terminal, a REFIN terminal, and a GND terminal (see FIG. 10). An analog power supply voltage is supplied, to the AVDD terminal, from the high-level side power supply circuit of the source power supply circuit 9. A digital power supply voltage is supplied from the logic power supply circuit 10 to the VSD terminal. Note that a low-level side of the digital power supply voltage is connected to a ground (GND). The SET terminal, the DVR terminal, the OUT/INPCOM terminal, the OUTCOM terminal, and the INNCOM terminal are each a terminal for a counter voltage. Note, however, that, according to the present embodiment, these terminals are not used because the counter electrode is grounded (i.e., the counter electrode is fixed to the ground electric potential (0V)). According to the present embodiment, the SCL terminal and the SDA terminal, each of which is a communication port of an I2C connected to outside, can be used to carry out, from outside, rewriting process of BANKA/B memories (storage sections). The BANKA/B memories are each nonvolatile memory which (i) stores voltage set values (gradation set voltages) corresponding to a respective plurality of gradation values and (ii) supplies the voltage set values thus stored to respective DATA 1 through DATA 10. Each of the DATA 1 through the DATA 10 stores a corresponding voltage set value and supplies the corresponding voltage set value thus stored to a 10-bit DAC. The 10-bit DAC converts, in accordance with a voltage set value, digital data corresponding to a gradation value of image data into a voltage. For example, in a case where the gradation value of the digital data is 356, the 10-bit DAC outputs a voltage of [(a voltage of the REFIN terminal−a voltage of GND terminal)×356/1023+GND]. Note that the voltage of the REFIN terminal is set by two resistors Ra and Rb illustrated in an upper section of FIG. 10. Power is supplied from the low-level side power supply circuit 9b of the source power supply circuit 9 to the GND terminal. The output of the 10-bit DAC is amplified by an amplifier and is then supplied, as a gradation reference voltage, from output terminals OUT 1 through OUT 10 to the source driver 5.

In accordance with the control signal supplied from the timing controller 2 and the gradation reference voltage supplied from the gradation DAC 3, the source driver 5 controls voltages to be applied to the respective source bus lines 32 provided on the TFT substrate 21 of the liquid crystal panel 20. Specifically, the source driver 5 generates electric potentials to be applied to the respective source bus lines 32 (i.e., electric potentials to be applied to picture elements 33 to be subjected to writing, among the picture elements 33 connected to the respective source bus lines 32). The source driver 5 then applies the electric potentials thus generated to the respective source bus lines 32, in synchronization with a timing when the gate driver 4 selects a gate bus line 31, via which writing is carried out.

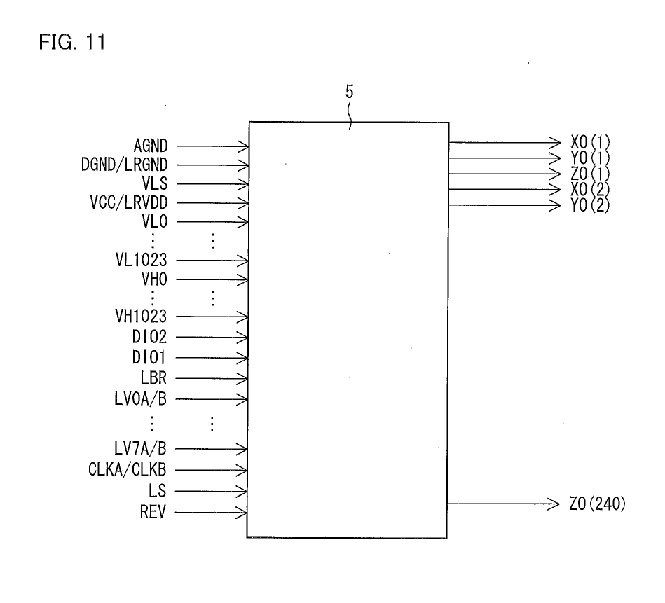

FIG. 11 is an explanatory diagram illustrating a configuration of the source driver 5. Note that the present embodiment employs a normally black liquid crystal panel 20 in which picture elements 33 are displayed in black in a case where no electric potential is applied to the picture elements 33. Note, however, that the present embodiment is not limited to this. Alternatively, a normally white liquid crystal panel 20 can be employed.

As illustrated in FIG. 11, the following (i) through (xii) are supplied to the source driver 5 (i) a ground electric potential AGND of analog power supply, (ii) an analog power supply VLS, (iii) ground electric potentials DGND/LRGND for logic circuits, (iv) logic power supplies VCC/LRVDD, (v) gradation reference power supplies VL0, . . . , VL1023, each of which is used in a case where the polarity of the voltage applied to the source bus line 32 is made to be a negative polarity, (vi) gradation reference power supplies VH0, . . . , VH1023, each of which is used in a case where a polarity of a voltage applied to the source bus line 32 is made to be a positive polarity, (vii) cascade signals DIO2 and DIO1, each of which is used in a case where a plurality of source drivers 5 are employed, (viii) a switching signal LBR for switching an order of data corresponding to an input signal (i.e., whether pixel data is arranged in an order from 1 to 240 or the pixel data is arranged in an order from 240 to 1), (ix) picture element data LV0A/B, . . . , LV7A/B, (x) clock signals CLKA/CLKB, (xi) a latch pulse LS which controls a timing for switching output data, and (xii) a polarity reverse signal REV for reversing a polarity of a voltage to be applied to the source bus line 32.

XO (1), YO (1), ZO (1), XO (2), YO (2), ZO (2), . . . , XO (240), YO (240), and ZO (240) are connected to respective different source bus lines 32 and drive picture elements 33 connected to the respective source bus lines 32. X, Y, and Z which correspond to colors of the respective picture elements and indicate one of three primary colors R, G, and B, depending on an arrangement order of the picture elements R, G, and B.

Liquid crystal molecules are polar molecules. Accordingly, in a case where an electric field is continuously applied, in an identical direction, to liquid crystal molecules for a long time, the liquid crystal molecules are polarized. This causes image sticking and/or deviation in characteristic to occur. In view of the circumstances, the source driver 5 of the present embodiment carries out an AC drive (i.e., a polarity reversal drive). According to such an AC drive, an electric potential applied to each picture element electrode 35 is alternately switched, in accordance with the control signal supplied from the timing controller 2, between (i) an electric potential which has a positive polarity and is higher than that of a counter electric potential and (ii) an electric potential which has a negative polarity and is lower than that of the counter electric potential. The polarity reverse signal REV is a signal for carrying out the switching of the electric potential applied to each picture element electrode 35. In a case where the polarity reverse signal REV is high level (H), a polarity of a voltage applied to each of XO(1), YO(1), ZO(1), XO(2), YO(2), ZO(2), . . . is +, −, +, −, +, −, . . . . Meanwhile, in a case where the polarity reverse signal REV is low level (L), the polarity of the voltage applied to each of XO(1), YO(1), ZO(1), XO(2), YO(2), ZO(2), . . . is switched to −, +, −, +, −, +, . . . . Note that the polarity of the applied voltage can be reversed for each of picture elements adjacent to each other in a direction in which the source bus line 32 extends. Alternatively, the polarity of the applied voltage can be reversed every two or more picture elements. Moreover, the polarity of the applied voltage can be reversed for each picture element or every two or more picture elements adjacent to each other in a direction in which the gate bus line 31 extends. According to the present embodiment, the polarity of the voltage to be applied to each of the picture elements is reversed for each frame or every two or more frames.

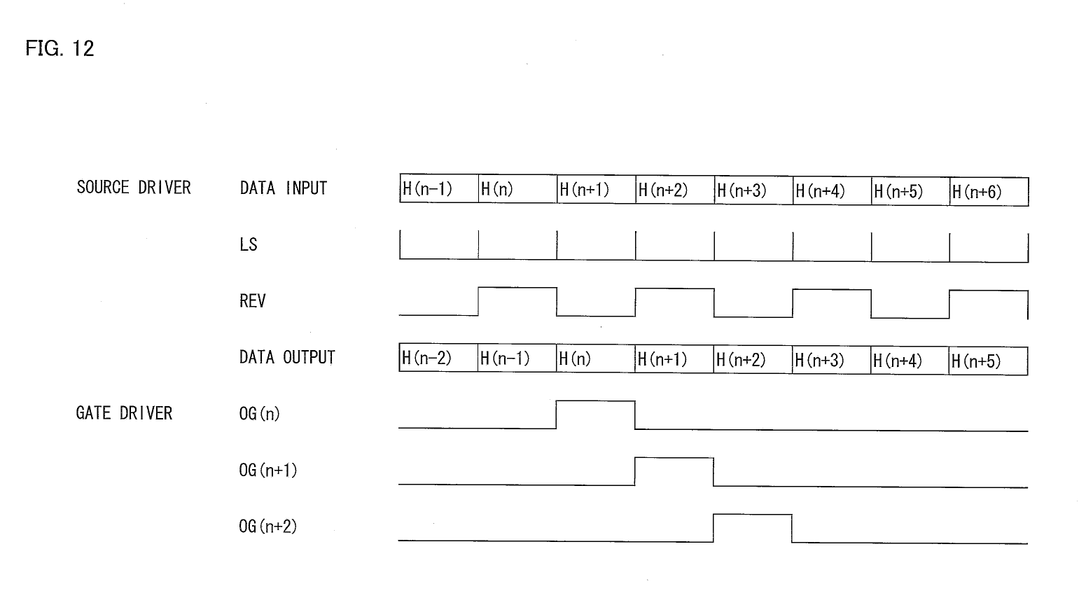

FIG. 12 is an explanatory diagram illustrating timings when voltages are applied to the source bus lines 32 and the gate bus lines 31. In synchronization with a latch pulse LS, the source driver 5 supplies electric potentials, which correspond to image data and correspond to one (1) gate bus line, to the respective source bus lines 32 (see FIG. 12). In synchronization with the output of the source driver 5, the gate driver 4 switches, to high level, a voltage which (i) is to be supplied to the gate bus lines 31 and (ii) corresponds to the output of the source driver 5. That is, during a period during which a voltage of an nth gate bus line 31 is high level, data in the nth line is supplied from the source driver 5 to the source bus lines 32. Each of the picture elements 33 is charged in accordance with the image data, by sequentially carrying out the above processing with respect to all the gate bus lines 31. In this way, display for one (1) screen is carried out.

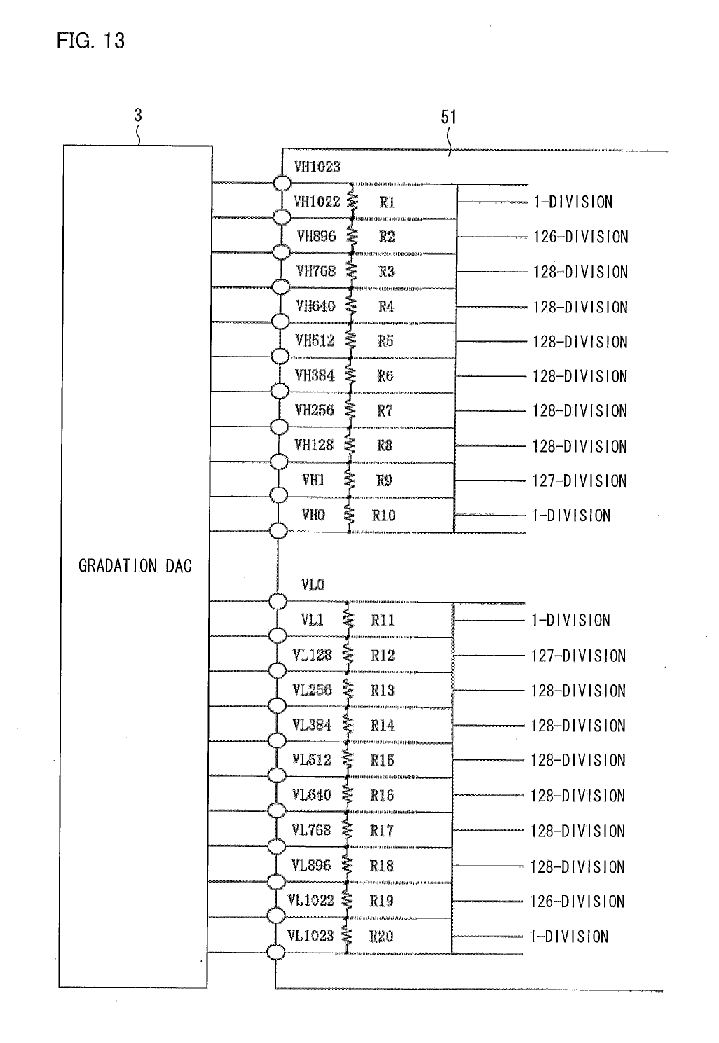

FIG. 13 is an explanatory diagram illustrating a circuit configuration of a gradation electric potential generation circuit 51 provided in the source driver 5. As has been described, transmittance of each of the picture elements of the liquid crystal panel 20 is adjusted by controlling a voltage to be applied to the picture element electrode of the each of the picture elements so as to carry out gradation display. Moreover, according to the present embodiment, the AC drive is carried out in which (i) voltages to be applied to any adjacent picture elements have respective reverse polarities and (ii) a polarity of a voltage to be applied to each picture element is reversed for each frame. According to the present embodiment, in order to carry out the AC drive, the gradation electric potential generation circuit 51 generates, in accordance with the gradation reference voltage supplied from the gradation DAC 3, the following two electric potentials for one (1) gradation value, that is, (i) an electric potential for a case where a voltage having a positive polarity is applied and (ii) an electric potential for a case where a voltage having a negative polarity is applied. Specifically, the present embodiment employs a 10-bit source driver 5, and the gradation electric potential generation circuit 51 generates 2048 types of electric potentials in total, that is, 1024 types of electric potentials VH0 thorough VH1023 for positive polarity and 1024 types of electric potentials VL0 through VL1023 for negative polarity. Note that resistances of the respective resistors R1 through R20 (see FIG. 13) are each set in accordance with a characteristic of a liquid crystal. In a case where no gradation reference voltage is supplied from the gradation DAC 3 to the gradation electric potential generation circuit 51, it is also possible to generate a gradation reference voltage obtained via the resistance divider by the resistors R1 through R20.

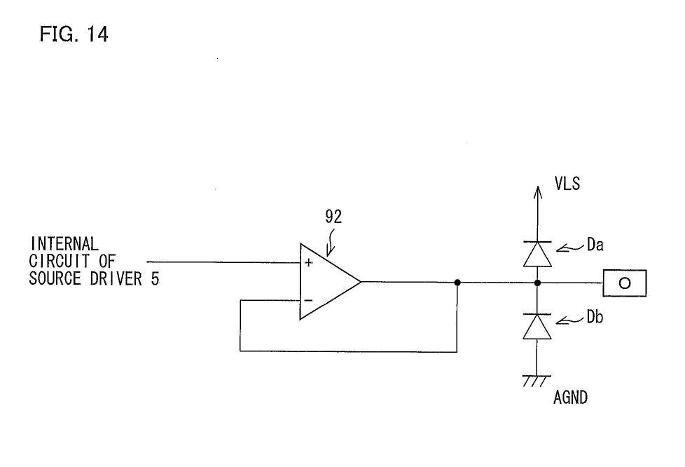

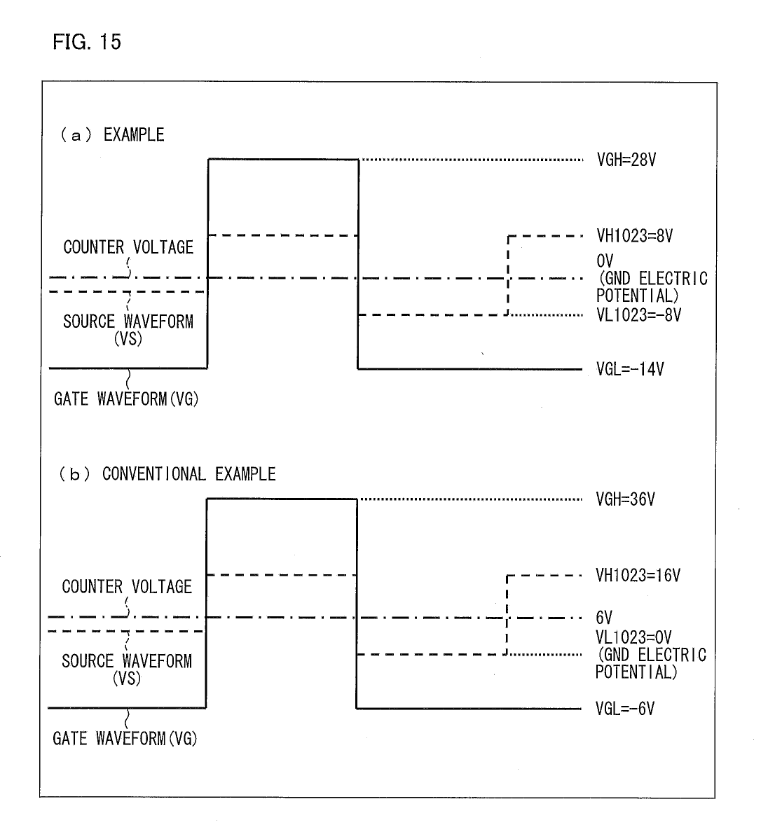

FIG. 14 is an explanatory diagram illustrating an example circuit configuration employed as an output stage of the source driver 5. The output stage of the source driver 5 includes an operational amplifier 92 provided between an internal circuit and an output terminal O of the source driver 5 (see FIG. 14). Further, an analog power supply VLS is connected, via a diode Da, between the operational amplifier 92 and the output terminal O, whereas a ground electric potential AGND of analog power supply is connected, via a diode Db, between the operational amplifier 92 and the output terminal O. In the internal circuit of the source driver 5, a voltage corresponding to a gradation value of a picture element of image data is selected from the gradation voltages illustrated in FIG. 13. The voltage thus selected is amplified by the operational amplifier 92 of the output stage and is then supplied to the source bus line 32.

(a) of FIG. 15 is an explanatory diagram illustrating example waveforms of respective voltages to be applied to each of the picture elements 33 of the liquid crystal display device 1 in accordance with the present embodiment. A gate waveform (VG), a source waveform (VS), and a counter electric potential indicate a waveform of a voltage applied to a gate terminal of the TFT 34, a waveform of a voltage applied to a source terminal of the TFT 34, and a waveform of a voltage applied to the counter electrode 36, respectively. According to the present embodiment, the voltage to be applied to the gate terminal (i) is set to 28V (a high-level side voltage) and (ii) is set to be −14V (a low-level side voltage) (see (a) of FIG. 15). The voltage to be applied to the source terminal is set so that (i) a maximum voltage (VH1023) for positive polarity is 8V and (ii) a minimum voltage (VL1023) for negative polarity is −8V. The counter voltage is set to 0V (a GND electric potential). Note that (i) an input voltage supplied to each of the gate power supply circuit 8, the source power supply circuit 9, and the logic power supply circuit 10 is 12V and (ii) an output voltage (a logic voltage) of the logic power supply circuit 10 is 3.3V.

As described above, the high-level side voltage to be applied to the gate terminal is set to be sufficiently higher than the maximum voltage to be applied to the source terminal so that the TFT 34 is turned on regardless of the voltage to be applied to the source terminal. Meanwhile, the low-level side voltage to be applied to the gate terminal is set to be sufficiently lower than the minimum voltage to be applied to the source terminal so that the TFT 34 is turned off regardless of the voltage to be applied to the source terminal. As such, in a case where a voltage of high level is applied to the gate terminal, the TFT 34 is turned on so that an electric current flows through the source terminal and the drain terminal. This causes an electric potential of the picture element electrode 35 to be equal to that of the source bus line 32, thereby causing writing in the picture element 33 to be carried out.

Meanwhile, (b) of FIG. 15 is an explanatory diagram illustrating a setting example of a conventional applied voltage. According to the setting example, it is assumed that a liquid crystal display device having a configuration substantially identical to that of the liquid crystal display device 1 of the present embodiment, except that voltages to be applied to the gate bus line 31 and the source bus line 32 are differently set.

As illustrated in (b) of FIG. 15, according to a conventional method of setting an applied voltage, a voltage to be applied to the source terminal is set so that (i) a maximum voltage (VH1023) for positive polarity is approximately 16V and (ii) a minimum voltage (VL1023) for negative polarity is 0V (the GND electric potential). The counter voltage is set to 6V. Note that a difference between (i) the maximum voltage to be applied to the source terminal and (ii) the counter voltage (16V −6V=10V) differs from a difference between (a) the counter voltage and (b) the minimum voltage to be applied to the source terminal (6V−0V=6V). This is because influence of feed-through to the GND (described later) which feed-through occurs when the picture element electrode is charged is taken into consideration.

That is, according to the conventional liquid crystal display device, (a) a minimum voltage to be applied to a source terminal of a TFT of a picture element was set to the GND electric potential, (b) a counter voltage was set to a positive voltage, and (c) the voltage to be applied to the source terminal of the picture element was set to a voltage of not less than 0V (the GND electric potential), regardless of whether the applied voltage has a positive polarity or a negative polarity. On the other hand, according to the liquid crystal display device 1 of the present embodiment, (i) the minimum voltage to be applied to the source terminal of the TFT 34 of the picture element 33 is set to a voltage lower than the GND electric potential and (ii) the counter voltage is set to the GND electric potential.

Note that, according to a liquid crystal display device, in general, feed-through to the GND electric potential occurs due to a floating capacitance in a liquid crystal panel. This causes a voltage to be applied to a picture element electrode to be shifted toward a GND, regardless of whether the applied voltage has a positive polarity or a negative polarity. That is, due to the feed-through to the GND electric potential, the applied voltage decreases in a case where the applied voltage has a positive polarity with respect to the GND electric potential, whereas the applied voltage increases in a case where the applied voltage has a negative polarity with respect to the GND electric potential. However, if a feed-through characteristic for positive polarity deviates from a feed-through characteristic for negative polarity, then an electric charge to be applied to a picture element having a positive polarity differs from an electric charge to be applied to a picture element having a negative polarity even in a case where identical gradation values are displayed. This causes a phenomenon so-called a flicker in which a screen flickers.

In view of the circumstance, the conventional liquid crystal display device has addressed the influence of the feed-through due to the floating capacitance, by adjusting the counter voltage. Moreover, since the floating capacitance varies from liquid crystal panel to liquid crystal panel, the adjustment has been made with respect to individual liquid crystal display devices.

On the other hand, according to the liquid crystal display device 1 of the present embodiment, the counter voltage is fixed to 0V (the GND electric potential). Accordingly, the influence of the feed-through due to the floating capacitance is eliminated by rewriting, in accordance with a characteristic of each liquid crystal panel (characteristics of individual liquid crystal display devices 1), a value of each of the BANKA/B memories of the gradation DAC 3 so as to adjust a voltage value corresponding to each gradation.

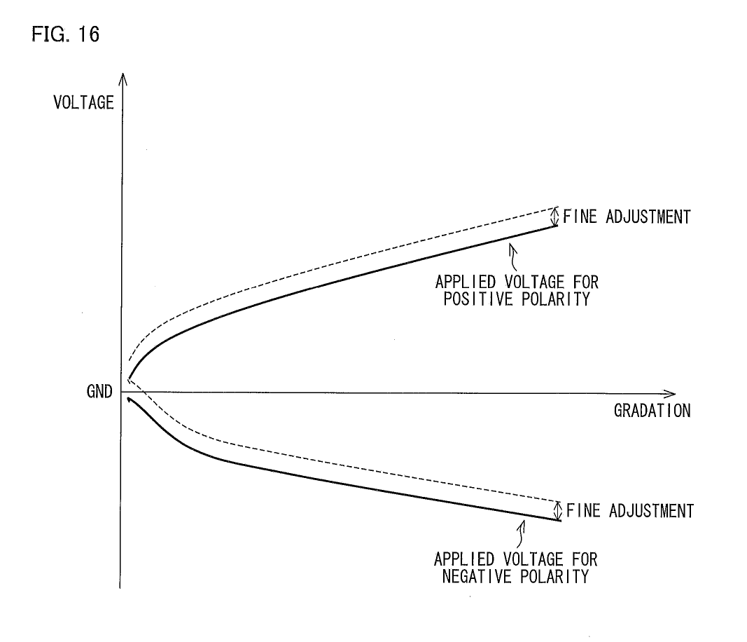

FIG. 16 is an explanatory diagram illustrating how an applied voltage corresponding to a gradation value is adjusted. By adjusting a set value of each of the BANKA/B memories of the gradation DAC 3, it is possible to adjust, in accordance with the set vale, a gradation voltage generated by the source driver 5.

The liquid crystal display device 1 of the present embodiment is thus configured such that the minimum electric potential to be applied to the source terminal of the TFT 34 of the picture element 33 is set to an electric potential lower than the ground (GND) electric potential. This makes it easier for an electric charge which has been accumulated in the picture element 33 to be discharged when the power supply to the liquid crystal display device 1 is turned off.

That is, when the power supply to the liquid crystal display device 1 is turned off, an electric charge of an output voltage of each of the gate power supply circuit 8, the source power supply circuit 9, and the logic power supply circuit 10 is discharged to the ground. This causes (i) the output voltage of each of the gate power supply circuit 8, the source power supply circuit 9, and the logic power supply circuit 10 to become 0V and (ii) the counter voltage to remain to be 0V.

Meanwhile, an electric charge of each of picture elements 33 connected to a source bus line 32 leaks to the source bus line 32. This causes an electric potential of the source bus line 32 to reach an electric potential corresponding to an average of voltages to be written in the respective picture elements. Accordingly, in a case of the conventional method of setting an applied voltage (see (b) of FIG. 15), the electric potential of the source bus line becomes approximately 8V. On the other hand, according to the liquid crystal display device 1 of the present embodiment, the minimum electric potential which is applied, during normal driving, to the source terminal of the TFT 34 of the picture element 33 is set to an electric potential lower than the ground (GND) electric potential. This causes an electric potential, which is applied to the source bus line 32 when the power supply is turned off, to become approximately 0V.

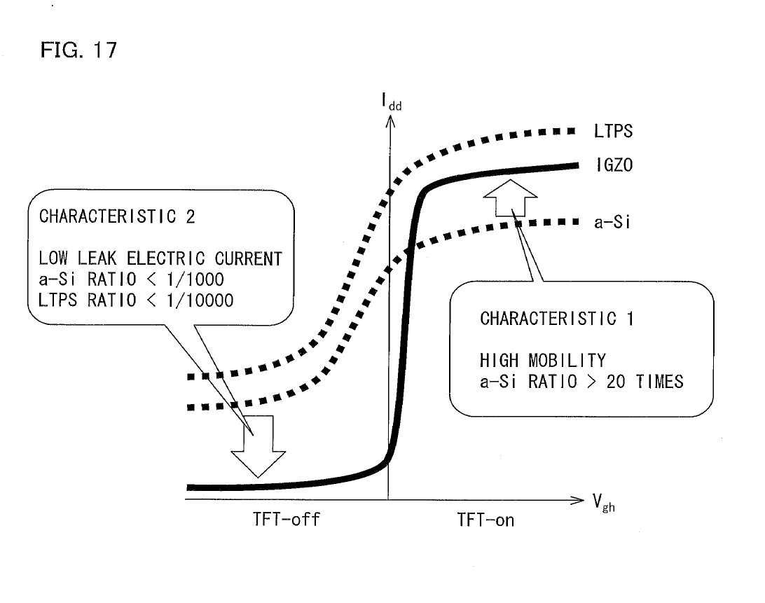

As is clear from the characteristic of the off-leak electric current of the TFT (see FIG. 17), in a case where a minimum electric potential, which is applied to the source terminal of the TFT 34, is set to an electric potential lower than the ground electric potential as in the present embodiment, it is possible to increase an off-leak electric current of the TFT, which off-leak electric current is generated when the power supply is turned off. This facilitates discharging of an electric charge which has been accumulated in the picture element 33.

Moreover, according to the conventional method of setting an applied voltage (see (b) of FIG. 15), when the power supply is turned off, the electric potential of the counter electrode changes, to the ground electric potential (0V), from a set electric potential (6V) which the counter electrode should have during driving. This causes a voltage charged in each of the picture elements to increase by an amount corresponding to such a change. As such, an electric charge, which needs to be discharged from the each of the picture elements, increases by the amount corresponding to the change.

On the other hand, according to the present embodiment, an electric potential, which the counter electrode 36 should have during driving, is set to the ground electric potential (0V). As such, the electric potential of the counter electrode 36 will never change even in a case where the power supply to the liquid crystal display device 1 is turned off. Accordingly, as compared with the conventional method, it is possible to more reduce an electric charge which needs to be discharged from the picture element 33 when the power supply is turned off.

In a case where the electric potential, which the counter electrode 36 should have during driving, is set to the ground electric potential (0V), it is further possible to facilitate discharging of the electric charge from the picture element electrode 35. That is, in a case of configuring the electric potential of the counter electrode 36 is adjustable, the counter electrode 36 has a high resistance against the ground electric potential. It becomes difficult for the counter electrode 36 to have a stable electric potential. This makes it difficult for the electric charge to be discharged from the picture element electrode 35. Meanwhile, in a case where the electric potential, which the counter electrode 36 should have during driving, is set to the ground electric potential (0V), the counter electrode 36 has a stable electric potential. This facilitates discharging of the electric charge from the picture element electrode 35.

According to the conventional liquid crystal display device, for example, as in Patent Literature 1, it has been necessary to provide (i) a circuit which carries out processing for discharging an electric charge from the picture element electrode when the power supply is turned off and (ii) charging means, such as capacitor, for driving the circuit even in a state in which a power supply is turned off. On the other hand, according to the present embodiment, an electric charge of each of the picture elements can be discharged, instead of providing such circuit and such charging means, when the power supply is turned off, only by providing the low-level side power supply circuit 9b in the source power supply circuit 9. This allows a reduction in production cost of the liquid crystal display device 1.

Note, however, that a liquid crystal display device 1 of the present embodiment can be alternatively configured such that (i) an applied voltage which is applied during driving is set as has been described and (ii) the circuit and the charging means are further provided so as to carry out processing for writing, in each of the picture elements, an electric potential (i.e., the ground electric potential or an electric potential close to the ground electric potential) for reducing an electric charge which is accumulated in each of the picture elements when the power supply is turned off.

Note that the present embodiment has discussed a configuration in which the electric potential of the counter electrode 36 is set to the ground electric potential (0V). Note, however, that the present embodiment is not limited to this. The same effect can be brought about at least by (i) setting, to be lower than the ground electric potential, a minimum electric potential of electric potentials which are applied to source bus lines 32 in accordance with image data, (ii) setting, to be higher than the ground electric potential, a maximum electric potential of the electric potentials which are applied to the source bus lines 32 in accordance with the image data, and (iii) appropriately setting an electric potential of the counter electrode 36 in accordance with the minimum electric potential and the maximum electric potential.

The present embodiment has discussed a case where the liquid crystal display device 1 is a transmissive liquid crystal display device which displays an image by use of light emitted from the backlight 30. However, the present embodiment is not limited to this. For example, the liquid crystal display device 1 can be a reflective liquid crystal display device in which externally entered light is reflected and is used as display light. Alternatively, the liquid crystal display device 1 can be a semi-transmissive liquid crystal display device which has both a function of a transmitting-type liquid crystal display device and a function of a reflective liquid crystal display device in combination.

The present embodiment has discussed the liquid crystal display device which is configured such that the TFT substrate 21 includes the picture element electrode and the counter substrate 22 includes the counter electrode. However, the present embodiment is not limited this. Alternatively, the liquid crystal display device can be configured such that the picture element electrode and the counter electrode are both provided on a single substrate.

### SUMMARY

A liquid crystal display device of Embodiment 1 of the present invention includes: a plurality of picture elements having respective switching elements each being constituted by a thin film transistor, the liquid crystal display device driving, in accordance with image data, picture elements corresponding to respective thin film transistors by applying electric potentials corresponding to the image data to source terminals of the respective thin film transistors during a period in which an electric potential for turning on the thin film transistors is applied to gate terminals of the respective thin film transistors, a minimum electric potential of the electric potentials which are applied to the respective source terminals in accordance with the image data being set to be lower than a ground electric potential.

With the configuration, it is possible for an electric potential of each of the source terminals to get close to the ground electric potential when a power supply to the liquid crystal display device is turned off, as compared with a conventional liquid crystal display device in which a minimum electric potential of electric potentials which are applied to source terminals in accordance with image data is the ground electric potential. This allows an increase in off-leak electric current which each of the switching elements has when the power supply is turned off. As such, it is possible to facilitate discharging of an electric charge which has been accumulated in each of the picture elements.

According to Embodiment 1, a liquid crystal display device of Embodiment 2 of the present invention is configured such that: the thin film transistor includes a channel layer made of oxide semiconductor.

The thin film transistor including a channel layer made of oxide semiconductor has a characteristic in which an off-leak electric current is extremely small. With the configuration, however, it is possible to increase an off-leak electric current which each of the switching elements has when the power supply is turned off, as compared with a conventional liquid crystal display device in which a minimum electric potential of electric potentials which are applied to source terminals is the ground electric potential. As such, it is possible to facilitate discharging of an electric charge which is accumulated in each of the picture elements.

According to Embodiment 1 or 2, a liquid crystal display device of Embodiment 3 of the present invention is configured such that: each of the plurality of picture elements includes (i) a picture element electrode connected to a drain terminal of a corresponding thin film transistor and (ii) a counter electrode provided so as to face the picture element electrode via a liquid crystal layer; an electric potential which the counter electrode has in a case where the each of the plurality of picture elements is driven in accordance with image data, is set to the ground electric potential.

With the configuration, the electric potential, which the counter electrode should have during driving, is set to the ground electric potential. As such, the electric potential of the counter electrode will never change even in a case where the power supply to the liquid crystal display device is turned off. Accordingly, an electric charge which needs to be discharged from the picture element does not be increased by a change in electric potential of the counter electrode. This facilitates discharging of the electric charge of the picture element. In a case where the electric potential of the counter electrode is set to be the ground electric potential, the counter electrode has a stable electric potential. This facilitates discharging of the electric charge of the picture element, as compared with a case where the electric potential of the counter electrode changes.

According to Embodiment 3, a liquid crystal display device of Embodiment 4 of the present invention further includes: a storage section which stores pieces of gradation reference data in which gradation values of image data are associated with electric potentials applied to the source terminals, which electric potentials correspond to the gradation values, the pieces of gradation reference data being changeable in accordance with characteristics of individual liquid crystal display devices.

With the configuration, it is possible to adjust, in accordance with the characteristics of individual liquid crystal display devices, a voltage applied to the source terminal of each of the picture elements corresponding to the gradation value of the image data. This prevents a problem such as a flicker so as to improve a display quality of the liquid crystal display device.

According to Embodiment 3 or 4, a liquid crystal display device of Embodiment 5 of the present invention further includes: a plurality of gate bus lines; and a plurality of source bus lines intersecting with the plurality of gate bus lines, the plurality of picture elements being provided for respective intersections of the plurality of gate bus lines and the plurality of source bus lines, a gate terminal of a thin film transistor provided in each of the plurality of picture elements being connected to one of the plurality of gate bus lines, a source terminal of the thin film transistor provided in the each of the plurality of picture elements being connected to one of the plurality of source bus lines, a polarity of an electric potential applied to the source terminal of the each of the plurality of picture elements, which source terminal is connected to a common source bus line, being set to be reversed for each picture element or every two or more picture elements adjacent to each other in a direction in which the common source bus line extends.

With the configuration, the electric potential which is applied, when the power supply is turned off, to each of the source bus lines is a value close to an average of the electric potentials which are applied to the respective picture elements connected to the source bus lines. Accordingly, it is possible for the electric potential, which is applied to each of the source bus lines, to get close to the ground electric potential when the power supply is turned off. This facilitates discharging of the electric charge of each of the picture elements.

A method of driving a liquid crystal display device of an embodiment of the present invention is configured such that: a plurality of picture elements having respective switching elements each being constituted by a thin film transistor, the liquid crystal display device driving, in accordance with image data, picture elements corresponding to respective thin film transistors by applying electric potentials corresponding to the image data to source terminals of the respective thin film transistors during a period in which an electric potential for turning on the thin film transistors is applied to gate terminals of the respective thin film transistors, the method including the step of: setting, to be lower than a ground electric potential, a minimum electric potential of the electric potentials which are applied to the respective source terminals in accordance with the image data.

With the method, it is possible for an electric potential of each of the source terminals to get close to the ground electric potential when a power supply to the liquid crystal display device is turned off, as compared with a conventional liquid crystal display device in which a minimum electric potential of electric potentials which are applied to source terminals in accordance with image data is the ground electric potential. This allows an increase in off-leak electric current which each of the switching elements has when the power supply is turned off. As such, it is possible to facilitate discharging of an electric charge which has been accumulated in each of the picture elements.

The present invention is not limited to the description of the embodiments above, but may be altered by a skilled person in the art within the scope of the claims. An embodiment based on a proper combination of technical means disclosed in different embodiments is encompassed in the technical scope of the present invention. Moreover, a new technical feature can be obtained from a proper combination of technical means disclosed in different embodiments.

### INDUSTRIAL APPLICABILITY

The present invention is applicable to a liquid crystal display device. The present invention is particularly applicable to a liquid crystal display device which employs, as a switching element, for example, a thin film transistor which (i) has a small off-leak electric current and (ii) is made of oxide semiconductor.

### REFERENCE SIGNS LIST

1: Liquid crystal display device
2: Timing controller
3: Gradation DAC
4: Gate driver
5: Source driver
8: Gate power supply circuit
8a: High-level side power supply circuit
8b: Low-level side power supply circuit
9: Source power supply circuit
9a: High-level side power supply circuit
9b: Low-level side power supply circuit
10: Logic power supply circuit
20: Liquid crystal panel
21: TFT substrate
22: Counter substrate
23: Spacer
24: Liquid crystal layer
25: First polarizing plate
26: Second polarizing plate
30: Backlight
31: Gate bus line
32: Source bus line
33: Picture element
34: TFT
35: Picture element electrode
36: Counter electrode
37: Liquid crystal storage capacitor
51: Gradation electric potential generation circuit
91: Step-down converter
92 Operational amplifier
D1, D2: Diode
I1, I2: Inverter
Ra, Rb: Resistor
R1 through R20: Resistor

1. A liquid crystal display device, comprising:
a plurality of picture elements having respective switching elements each being constituted by a thin film transistor,
said liquid crystal display device driving, in accordance with image data, picture elements corresponding to respective thin film transistors by applying electric potentials corresponding to the image data to source terminals of the respective thin film transistors during a period in which an electric potential for turning on the thin film transistors is applied to gate terminals of the respective thin film transistors,
a minimum electric potential of the electric potentials which are applied to the respective source terminals in accordance with the image data being set to be lower than a ground electric potential.

2. The liquid crystal display device as set forth in claim 1, wherein the thin film transistor includes a channel layer made of oxide semiconductor.

3. The liquid crystal display device as set forth in claim 1, wherein:
each of the plurality of picture elements includes (i) a picture element electrode connected to a drain terminal of a corresponding thin film transistor and (ii) a counter electrode provided so as to face the picture element electrode via a liquid crystal layer;
an electric potential which the counter electrode has in a case where the each of the plurality of picture elements is driven in accordance with image data, is set to the ground electric potential.

4. The liquid crystal display device as set forth in claim 3, further comprising:
a storage section which stores pieces of gradation reference data in which gradation values of image data are associated with electric potentials applied to the source terminals, which electric potentials correspond to the gradation values,
the pieces of gradation reference data being changeable in accordance with characteristics of individual liquid crystal display devices.

5. The liquid crystal display device as set forth in claim 3, further comprising:
a plurality of gate bus lines; and
a plurality of source bus lines intersecting with the plurality of gate bus lines,
the plurality of picture elements being provided for respective intersections of the plurality of gate bus lines and the plurality of source bus lines,
a gate terminal of a thin film transistor provided in each of the plurality of picture elements being connected to one of the plurality of gate bus lines,
a source terminal of the thin film transistor provided in the each of the plurality of picture elements being connected to one of the plurality of source bus lines,
a polarity of an electric potential applied to the source terminal of the each of the plurality of picture elements, which source terminal is connected to a common source bus line, being set to be reversed for each picture element or every two or more picture elements adjacent to each other in a direction in which the common source bus line extends.

6. A method of driving a liquid crystal display device,
said device comprising:
a plurality of picture elements having respective switching elements each being constituted by a thin film transistor,
said liquid crystal display device driving, in accordance with image data, picture elements corresponding to respective thin film transistors by applying electric potentials corresponding to the image data to source terminals of the respective thin film transistors during a period in which an electric potential for turning on the thin film transistors is applied to gate terminals of the respective thin film transistors,
said method comprising the step of:
setting, to be lower than a ground electric potential, a minimum electric potential of the electric potentials which are applied to the respective source terminals in accordance with the image data.
